(19) United States
(12) Patent Application Publication
(10) Pub. No.: US 2003/0108063 A1
(43) Pub. Date: Jun. 12, 2003

(54) System and method for aggregating multiple information channels across a network

(76) Inventors: Moses S. Joseph, Carmel Valley, CA (US); Siddanagouda Sankanagouda, Fremont, CA (US)

Correspondence Address: CARR & FERRELL LLP, 2225 EAST BAYSHORE ROAD, SUITE 200, PALO ALTO, CA, 94303, US

(21) Appl. No.: 10/020,517

(22) Filed: Dec. 7, 2001

(51) Int. Cl. H04J 3/16

(52) U.S. Cl. 370/465; 370/474; 370/466; 370/412; 370/395.4

(57) ABSTRACT

A system and method for aggregating multiple information channels across a network is provided. The system is transparent to any of the technologies in the first two layers of the network hierarchy, without requiring any hardware or software modifications to the network equipment infrastructure. In addition, the system is portable to the existing capabilities at both the user's site and at the Internet service provider.

### FIELD OF THE INVENTION

This invention relates generally to a system and method for providing access to multiple information channels across a network. More specifically, the present invention provides a system and method for aggregating multiple information channels across a network using inverse multiplexing.

### BACKGROUND OF THE INVENTION

The popularity of the Internet has grown rapidly over the past several years. A decade ago, the Internet was limited to the academic and research community. Today, the Internet has grown into a communication network that reaches millions of people around the world. It provides a powerful and versatile environment for business, education, and entertainment. Millions of people worldwide access the Internet daily for communicating, retrieving information, shopping, recreating, and exploiting various other services. The increasing use of the Internet combined with the large number of services provided have created a virtually insatiable demand for faster, cheaper, and higher bandwidth Internet access.

Traditional Internet access has involved two options. First, Internet access is provided with the use of a computer with a direct connection to the Internet backbone. In this case, bandwidths of up to 100 Mbps are achieved, but at the cost of a very expensive infrastructure usually deployed only at large academic, governmental, and business institutions. Second, a very low cost solution to Internet access is provided with the use of a computer equipped with a modem that connects to the Internet backbone through existing telephone lines. While this solution has vastly popularized Internet use among home users, its low bandwidth of only up to 56 Kbps makes it impractical and frustrating for users to access a variety of Internet services requiring high transmission rates, especially multimedia intensive applications involving video and audio streaming.

To address the need for high bandwidth Internet access at an affordable price, a new set of technologies has recently been developed. Users can now choose between high speed Internet connections provided by T1 or T3 lines leased from telephone companies, cable modems, or digital subscriber lines (DSL). The first option, although still prohibitively expensive and not widely available, can carry data at a rate of up to 1.5 Mbps, roughly 60 times more than a normal residential modem, and requires a point-to-point dedicated physical connection between the user's computer and the telephone company's switch. The second option offers a relatively inexpensive Internet connection through existing cable lines. However, since the cable lines are shared by multiple users on the cable system, performance can suffer dramatically as users compete for the limited resources one cable can afford. Using a shared medium also creates security problems and cable modem users are much more vulnerable to data interception, unauthorized monitoring, and hacking from other users along the same cable network. In addition, only about 10% of the residential cable users have access to the upgraded cable systems needed to support cable modems.

Alternatively, digital subscriber line (DSL) technology provides high bandwidth Internet access over existing telephone lines. A typical DSL connection requires the user to have a DSL modem and/or router to connect to the DSL line provided by the telephone company. The DSL line is a dedicated telephone line that can typically achieve rates of 640 Kbps downstream (from the Internet to the user's computer) and 128 Kbps upstream (from the user's computer to the Internet), with the actual bandwidth depending on the distance from the user's computer to the telephone company's central office (the longer the distance, the slower the connection). Besides the DSL modem, all the other infrastructure required for Internet access is provided by the telephone company and is therefore transparent to the user. The only costs incurred by the user to have a much higher bandwidth connection to the Internet as compared to using a standard modem connection are the installation costs of the DSL modem and the service fees charged by the DSL service provider.

One of the major benefits of DSL technology is that in many cases, it allows the DSL signal to coexist on the same pair of copper wires as the existing voice line, allowing the user to talk on the telephone while simultaneously connected to the Internet. In addition, a single DSL line can be shared by multiple machines by using a router coupled with the DSL modem.

DSL therefore enables high-speed multimedia services such as video-on-demand, distance learning, videoconferencing, and shared business applications for anyone with access to a telephone line. Users demanding extensive use of such high-speed Internet services in their local area networks (LANs) may, however, require more bandwidth than provided by a single DSL line accessed by all the machines in the network. In this case, the user may choose to subscribe to higher bandwidth information channels such as T1 and T3 lines. Installing multiple DSL lines would not benefit the user, since each machine or group of machines would still be limited to the bandwidth provided by the single DSL line they are connected to.

With the limited availability and high costs of deploying higher bandwidth connections provided by T1 and T3 lines, recent technologies have been developed by Copper Mountain Networks, Inc., of Palo Alto, Calif., and by Netopia, Inc., of Alameda, Calif., to aggregate or bond multiple DSL lines together into a single “virtual” pipe to significantly increase the bandwidth available to end users. Installing multiple DSL lines provides a simple solution, achieving rates comparable to T1 connections at a much lower cost to the user.

However, these bonding technologies are complex to install, requiring considerable changes to the DSL service provider infrastructure or to the telephone company's central office infrastructure. In the case of the solution provided by Copper Mountain Networks, inverse multiplexing functionality is added to the DSL service provider infrastructure, and in the case of the solution provided by Netopia, specially designed routers are placed at the DSL service provider. In both cases, the telephone company and the DSL service provider must be able to support the specific technologies at the first two layers of the network layer hierarchy, such as the multilink point-to-point protocol (MPPP), and the multilink frame relay (MFR) technology. Therefore, both of these solutions are complex, expensive, require significant changes to the network infrastructure between the user's computer and the Internet (from the Internet router to DSL modems), and may not be at the reach of all DSL customers.

In view of the foregoing drawbacks for aggregating multiple digital subscriber lines across a network, it would be desirable to provide a system architecture for aggregating multiple information channels that does not require changing the network infrastructure provided between the two points of contact.

It also would be desirable to provide a system architecture for aggregating multiple information channels that is transparent to the technologies provided at the first two layers of the network layer hierarchy.

It further would be desirable to provide a system architecture for aggregating multiple information channels that is simple, has a low cost to implement, and is easily portable to the existing capabilities at both the user's site and at the Internet service provider.

It still further would be desirable to provide a system architecture for aggregating multiple information channels that include T1, fractional T3, and DSL lines, and standard Internet connections using modems.

### SUMMARY OF THE INVENTION

In view of the foregoing, it is an object of the present invention to provide a system architecture for aggregating multiple information channels that does not require changing the network infrastructure provided between the two points of contact.

It is also an object of the present invention to provide a system architecture for aggregating multiple information channels that is transparent to the technologies provided at the first two layers of the network layer hierarchy.

It is a further object of the present invention to provide a system architecture for aggregating multiple information channels that is simple, has a low cost to implement, and is easily portable to the existing capabilities at both the user's site and at the Internet service provider.

It is also a further object of the present invention to provide a system architecture for aggregating multiple information channels that include T1, fractional T3, and DSL lines, standard Internet connections using modems, and any other layer one and layer two technologies.

These and other objects of the present invention are accomplished by providing a system architecture for aggregating multiple information channels using inverse multiplexing. The inverse multiplexing architecture is capable of combining multiple physical access links such as T1, fractional T3, and DSL lines, as well as standard Internet connections using modems and any other layer one and layer two technologies, into one logical link at the third layer, i.e., the network or Internet protocol layer, of the network layer hierarchy. The inverse multiplexing architecture is transparent to any of the technologies in the first two layers of the network hierarchy, without requiring any hardware or software modifications to the network equipment infrastructure currently deployed between the user's premises and the Internet service providers' (ISPs) point of presence (POP). In addition, the inverse multiplexing architecture is very flexible, and may be deployed at other gateways and routers placed between the POPs. The inverse multiplexing architecture has a low implementation cost, and is easily portable to the existing capabilities at both the user's site and at the Internet service provider.

In a preferred embodiment, the system architecture of the present invention for aggregating multiple information channels consists of two components: (1) a premises service unit (PSU) at the user's site; and (2) a service gateway (SG) at the ISPs or another user's site. The system architecture provided is very flexible, enabling its two components to be either software-only solutions easily portable to any existing hardware at the user's site and at the ISPs, or a combination of hardware and software solutions. In the latter case, simple and low-cost special purpose chips can be designed, or existing hardware such as plain servers or personal computers from a variety of computer manufacturers may be provided with the software addition of the required architecture functionality.

The system architecture functionality is provided by three main modules: (1) a trunking protocol; (2) a packet scheduling algorithm; and (3) an information channel aggregation controller.

The trunking protocol enables the inverse multiplexing operation for aggregating multiple information channels by providing a continuous bidirectional flow of control and monitoring information between the PSU at the user's site and the SG at the ISPs. The trunking protocol is based on its own IP packet header to provide additional functions and enhancements to current protocol technologies at the third layer of the network layer hierarchy. The additional functions include: (1) packet encapsulation; (2) packet fragmentation; and (3) packet order preservation.

The packet scheduling algorithm enables efficient packet distribution across each of the information lines being aggregated at the PSU at the user's site. Each packet is sent on the link that has the shortest queue, so that all the information line capabilities are utilized properly to get the highest available bandwidth at any given time.

Lastly, the information channel aggregation controller provides general maintenance of configuration information for the information lines, including identifying and adding lines that may be aggregated, monitoring the status of the aggregated lines, forming aggregation groups containing a subset or all of the lines being aggregated, and adding and removing lines from a given aggregation group.

Advantageously, the present invention enables multiple information lines to be aggregated without requiring any hardware or software modifications to the network equipment infrastructure currently deployed between the user's premises and the ISPs.

In addition, the present invention has a low implementation cost, and is easily portable to the existing capabilities at both the user's site and at the ISPs, being transparent to the technologies provided at the first two layers of the network layer hierarchy.

### BRIEF DESCRIPTION OF THE DRAWINGS

The foregoing and the other objects of the present invention will be apparent upon consideration of the following detailed description, taken in conjunction with the accompanying drawings, in which like reference characters refer to like parts throughout, and in which:

FIG. 1 is a schematic view of a prior art network architecture to provide Internet access to a user's site through multiple DSL lines;

FIG. 2 is a schematic view of a preferred embodiment of a system architecture constructed in accordance with the principles of the present invention for aggregating multiple DSL lines at a user's site;

FIG. 3 is a schematic view of an alternative embodiment of a system architecture constructed in accordance with the principles of the present invention for aggregating multiple information lines at a user's site;

FIG. 4 is a schematic view of the functionalities provided by a system architecture constructed in accordance with the principles of the present invention;

FIG. 5 is a schematic view of the functionalities provided by the trunking protocol;

FIG. 6 is a schematic view of an illustrative trunking protocol header;

FIG. 7 is a schematic view of an illustrative packet transmitted in accordance with the principles of the present invention;

FIG. 8A is a flowchart for sending packets from the premises service unit to the service gateway;

FIG. 8B is a flowchart for receiving packets at the service gateway from the premises service unit;

FIG. 9A is a flowchart for sending packets from the service gateway to the premises service unit;

FIG. 9B is a flowchart for receiving packets at the premises service unit from the service gateway;

FIG. 10 is a flowchart of a packet scheduling algorithm for transmitting packets from the user's site to the multiple information lines;

FIG. 11 is a schematic view of an illustrative packet scheduling session for distributing packets to multiple information lines; and

FIG. 12 is a schematic view of the functionalities provided by the information channel aggregation controller.

### DETAILED DESCRIPTION OF THE INVENTION

The present invention provides a system architecture for aggregating multiple information channels using inverse multiplexing at the IP layer, i.e., the third layer of the network layer hierarchy. Inverse multiplexing, as used herein, refers to the aggregation of multiple independent information channels across a network to create a single information channel at a higher rate. The information channels include, but are not limited to, physical access links such as T1, fractional T3, and DSL lines, as well as standard network connections using modems. The inverse multiplexing architecture is transparent to any of the technologies in the first two layers of the network hierarchy, without requiring any hardware or software modifications to the network equipment infrastructure currently deployed between the user's premises and the Internet service providers' (ISPs) point of presence.

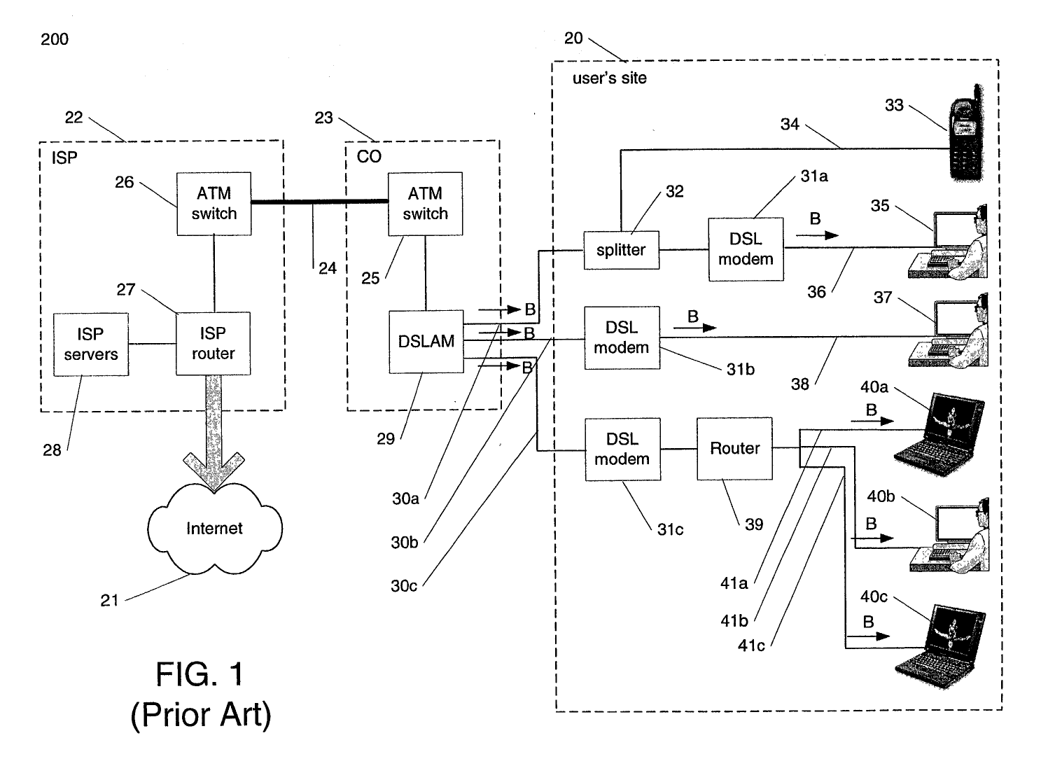

Referring to FIG. 1, a schematic view of a prior art network architecture to provide Internet access to a user's site through multiple DSL lines is described. User's site 20 has access to Internet 21 through Internet Service Provider (ISP) 22. Typically, ISP 22 offers users a variety of services, including e-mail, chat rooms, instant messaging, among others. These services are provided on a subscription basis, with each user paying ISP 22 a subscription fee that depends on the Internet connection at user's site 20. Examples of ISP 22 include America Online, Inc., from Dulles, Va., and EarthLink, from Atlanta, Ga.

User's site 20 connects to Internet 21 through Digital Subscriber Lines (DSLs) provided by central office (CO) 23 of the local telephone company. DSL technology essentially maximizes the potential of existing telephone lines by, in many cases, providing both voice and data on a single line. There are a variety of DSL technologies in use, with each one achieving different bandwidths, ranging anywhere from 64 Kbps to 8 Mbps. In general, these are asymmetric bandwidths, with the downstream bandwidth being much higher than the upstream bandwidth.

In a preferred embodiment, CO 23 is connected to ISP 22 through high-speed Asynchronous Transfer Mode (ATM) connection 24 between ATM switches 25 and 26 located in Co 23 and ISP 22, respectively. ATM is a switching technology ideally suitable for the different types of traffic shared between ISP 22 and CO 23, including voice, data, video, and multimedia. ATM switches 25 and 26 are responsible for configuring high-speed connection 24 to provide a guaranteed quality of service for the traffic shared between ISP 22 and CO 23. In addition, ATM switches 25 and 26 are the initial points of contact between CO 23 and Internet 21 and between CO 23 and user's site 20, respectively.

ATM switch 25 in ISP 22 is connected to ISP router 27, which handles the traffic distribution between CO 23 and Internet 21 and between ISP servers 28 and CO 23. It will be understood by one skilled in the art that ISP servers 28 may include a variety of servers, such as e-mail servers, web servers, billing and operations servers, network management servers, among others.

ATM switch 26 in CO 23 is connected to DSL Access Multiplexer 29, which aggregates traffic from users at user's site 20 and passes it to CO 23, and conversely, handles the distribution of traffic from CO 23 to user's site 20. Traffic between CO 23 and user's site 20 passes through multiple DSL lines 30a-c, with each line providing a maximum bandwidth of B from CO 23 to user's site 20 (downstream). The maximum bandwidth from user's site 20 to CO 23 (upstream) in any one of DSL lines 30a-c may not necessarily be equal to B, depending on whether the DSL line is symmetric or not. In case of an asymmetric DSL line, the traffic and bandwidth in the downstream direction is much larger than the traffic and bandwidth in the upstream direction, with typical rates of up to 640 Kbps/1.5 Mbps downstream and up to from 128 to 640 Kbps upstream. In contrast, symmetric DSL lines may provide bandwidths of typically up to 384 Kbps in either direction.

The maximum bandwidth provided to user's site 20 depends on the subscription agreement formed between the users and ISP 22. The maximum bandwidth is not always guaranteed as it depends on the length and condition of DSL lines 30a-c, and the thickness/gauge of the twisted pair connecting user's site 20 to CO 23 as well as the general conditions of Internet 21 at any given time. Further, it will be understood by one skilled in the art that DSLAM 29 may provide multiple others DSL connections to user's site 20 and to a variety of other user's sites (not shown).

Each one of DSL lines 30a-c is connected to user's site 20 by a respective one of DSL modems 31a-c. A DSL modem is a device that modulates the outgoing digital signals from a computer at user's site 20 to analog signals transmitted on a conventional copper DSL line, and conversely, demodulates the incoming analog signals from the DSL line to digital signals for the computer. In case the DSL line is shared between computers and a telephone, a splitter device at the user's site is employed to split the voice signals for the telephone and the data signals for the computers. This is the case of DSL line 30a that passes through splitter 32 prior to connecting to DSL modem 31a. Splitter 32 sends the voice signal on DSL line 30a to telephone 33, while DSL modem 31 sends the data signals to computer 35 on cable 34.

A single DSL modem can also be used for one or more computers, as in the case of DSL modems 31b-c. While DSL modem 31b is only connected to computer 37 through cable 38, DSL modem 31c enables DSL line 30c to be used by laptops 40a and 40c, as well as personal computer 40b. This requires the use of router 39 to handle the distribution of traffic on DSL line 30c to each one of computers 40a-c. Computers 40a-c are connected to DSL 39 through cables 41a-c, respectively. It will be understood by one skilled in the art that the network infrastructure between user's site 20 and ISP 22 involves all network equipment between ISP router 27 at ISP 22 and DSL modems 31a-c at user's site 20 (including ISP router 27 and DSL modems 31a-c).

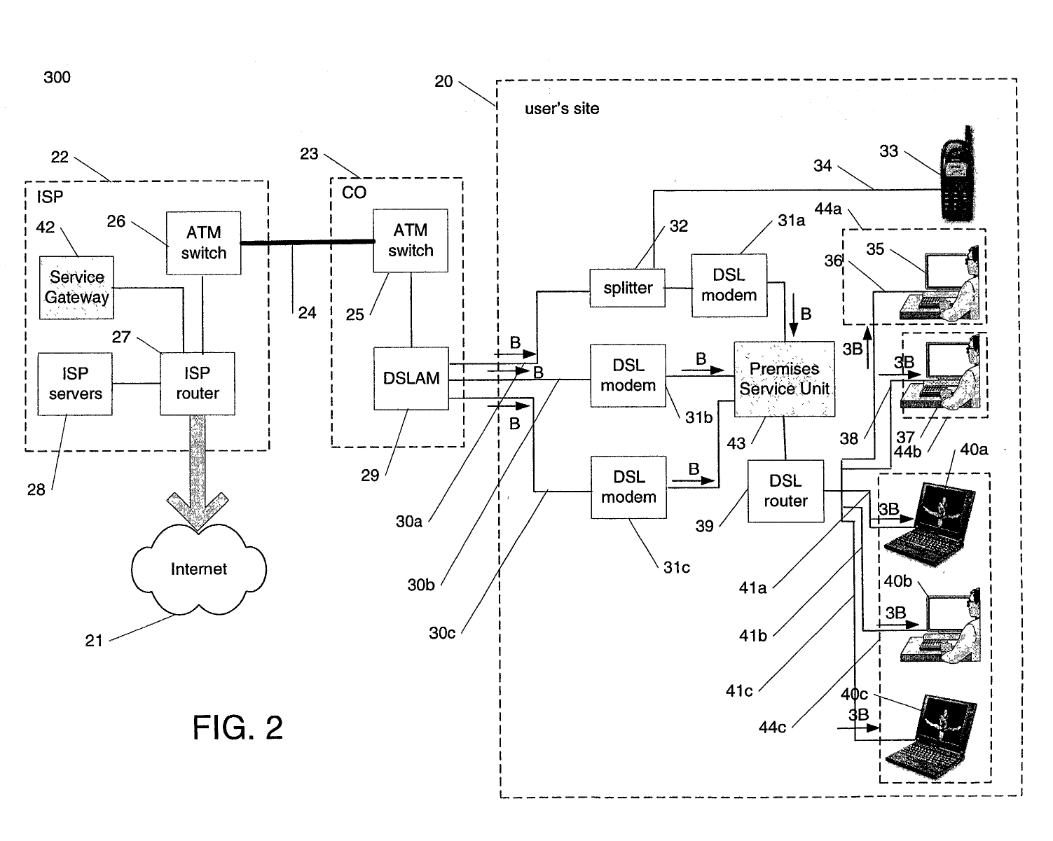

Referring now to FIG. 2, a schematic view of a preferred embodiment of a system architecture constructed in accordance with the principles of the present invention for aggregating multiple DSL lines at a user's site is described. System architecture 300 enables multiple DSL lines 30a-c to be aggregated without requiring any hardware or software modifications to the network equipment infrastructure currently deployed between the user's premises and the ISPs.

System architecture 300 consists of two additional components to system architecture 200 (shown in FIG. 1): service gateway (SG) 42 at ISP 22 and premises service unit (PSU) 43 at user's site 20. SG 42 and PSU 43 provide functionalities that may be either implemented in software or in hardware. In the case of a software-only implementation, SG 42 may consist of software modules added to ISP router 27 or to ISP servers 28, while PSU 43 may consist of software modules added to one or more of computers 35, 37, and 40a-c, as well as to router 39. In the case of a hardware implementation, SG 42 and PSU 43 may consist of simple and low-cost special purpose chips or plain servers from a variety of computer manufacturers, with both solutions providing the functionalities required to enable the aggregation of DSL lines 30a-c.

PSU 43 may integrate DSL lines 30a-c into different aggregation groups. Each group may contain one or more lines, and DSL lines may be added and removed from any given group. With SG 42 and PSU 43, computers 35, 37, and 40a-c are now able to receive a maximum bandwidth approaching approximately 3B, about three times higher than the maximum bandwidth provided without the aggregation of DSL lines 30a-c.

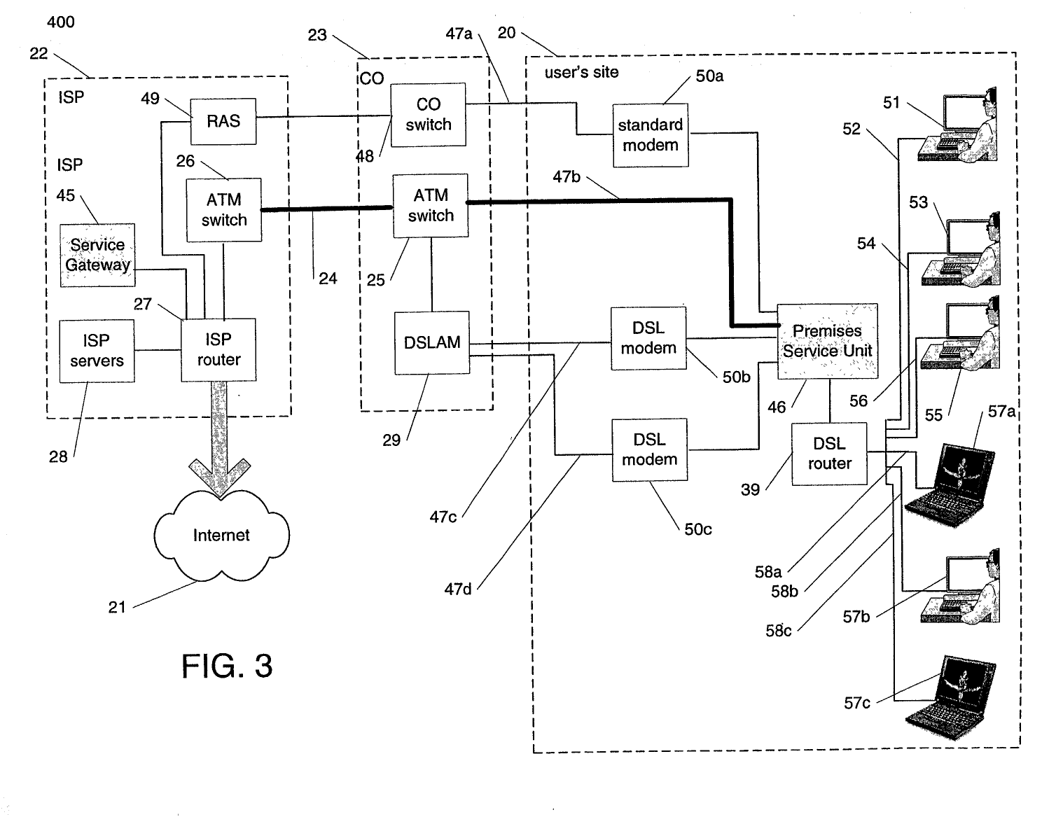

Referring now to FIG. 3, a schematic view of an alternative embodiment of a system architecture constructed in accordance with the principles of the present invention for aggregating multiple information lines at a user's site is described. System architecture 400 shown in FIG. 3 is able to aggregate standard telephone line 47a, high-speed connection 47b, and DSL lines 47c-d to provide computers 51, 53, 55, and 57a-c with a much higher bandwidth than the one achieved by each individual line. System architecture 400 consists of service gateway (SG) 45 at ISP 22 and premises service unit (PSU) 46 at user's site 20.

SG 45 and PSU 46 provide functionalities that may be either implemented in software or in hardware. In the case of a software-only implementation, SG 45 may consist of software modules added to ISP router 27, while PSU 46 may consist of software modules added to one or more of computers 51, 53, 55, and 57a-c, as well as to router 39. In the case of a hardware implementation, SG 45 and PSU 46 may consist of simple and low-cost special purpose chips or plain servers from a variety of computer manufacturers, with both solutions providing the functionalities required to enable the aggregation of telephone line 47a, high-speed line 47b, and DSL lines 47c-d. Telephone line 47a and high-speed line 47b connect user's site 20 to CO switch 48 at CO 23. CO switch 48 routes the user's telephone call to ISP 22 via remote access server (RAS) 49. While telephone line 47a first connects to standard modem 50a to convert the analog signals in telephone line 47a to digital signals prior to connecting to PSU 45, high-speed line 47b connects to PSU 45 directly. PSU 45 provides a much higher bandwidth on lines 52, 54, 56, and 58a-c connected to computers 51, 53, 55, and 57a-c than the bandwidth achieved by the individual lines.

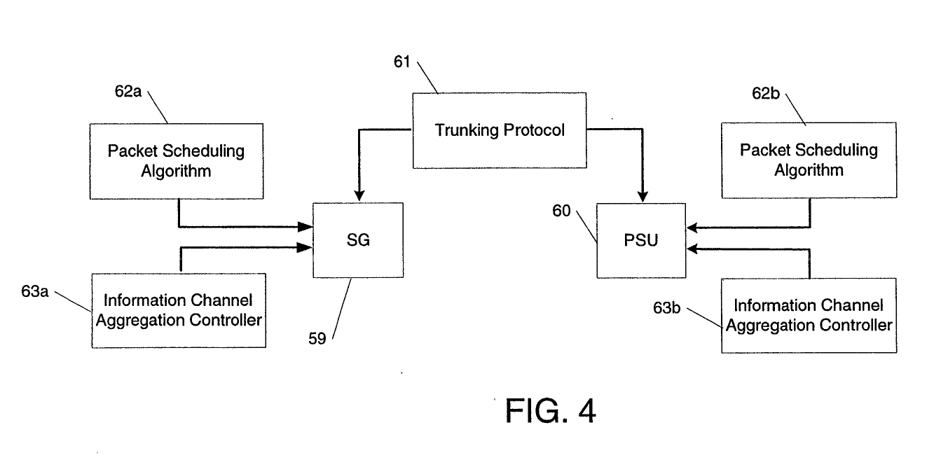

Referring now to FIG. 4, a schematic view of the functionalities provided by a system architecture constructed in accordance with the principles of the present invention is described. The functionalities provided by SG 59 and PSU 60 consist of the following three main modules: (1) trunking protocol 61 (including modules for implementing trunking protocol 61 in SG 59 and PSU 60); (2) packet scheduling algorithm 62a-b; and (3) information channel aggregation controller 63a-b. These modules can be implemented as software running on general or special purpose processors, and microcode or hardware logic in a processor or other electronic circuit (e.g., ASIC and FPGA).

Trunking protocol 61 enables the inverse multiplexing operation for aggregating multiple information channels by providing a continuous bidirectional flow of control and monitoring information between PSU 60 and SG 59. Trunking protocol 61 is based on its own packet header to provide additional functions and enhancements to current transport protocol technologies such as the TCP/IP and UDP protocols at the third layer of the network layer hierarchy. The additional functions include: (1) packet encapsulation; (2) packet fragmentation; and (3) packet order preservation.

Packet scheduling algorithm 62a-b enables efficient packet distribution across each of the information lines being aggregated at PSU 60. Each packet is sent on the link that has the shortest queue, so that all the information line capabilities are utilized properly to get the highest available bandwidth at any given time.

Lastly, information channel aggregation controller 63a-b provides general maintenance of configuration information for the information lines, including identifying and adding lines that may be aggregated (auto discovery of active lines), monitoring the status of the aggregated lines (error monitoring and recovering), forming aggregation groups containing a subset of the lines being aggregated, and adding and removing lines from a given aggregation group.

I. Trunking Protocol

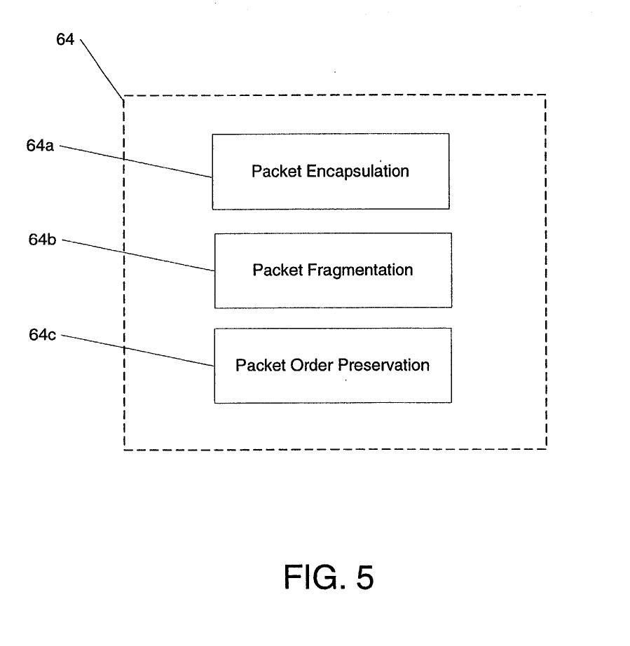

Referring now to FIG. 5, a schematic view of the functionalities provided by the trunking protocol is described. The trunking protocol provides additional functions and enhancements to current protocol technologies at the third layer of the network layer hierarchy. Trunking protocol functionalities 64 include: (1) packet encapsulation (64a); (2) packet fragmentation (64b); and (3) packet order preservation (64c).

Packet encapsulation 64a generates a trunking protocol header for each packet transmitted. The trunking protocol header may be included in a packet jointly with the header provided by standard transport protocols such as TCP/IP and UDP, or it may be the only header in the packet. Packet fragmentation 64b fragments packets of length L bytes or greater formed by the IP protocol into smaller packets so that the transmission rate of the aggregated lines is optimized. In a preferred embodiment, the packet length fragment consists of 300 bytes (without including the trunking protocol header), 5 times smaller than the maximum packet length typically used in IP networks (1500 bytes). From hereon, a packet fragment will be referred to simply as “packet”.

Packet order preservation 64c involves identifying any packets that may have been delayed due to network congestion or other conditions to provide the proper packet reordering. Since packets are sent over multiple information lines, differences in delay may cause some of the packets to arrive out of their original order. Packet order preservation 64c provides a buffer for the packets that are not received in sequence until the delayed packet arrives. If a packet is received in sequence, it will be immediately forwarded. Otherwise, the packet is stored in the buffer, and the retrieval and forwarding of the stored packet is attempted when the packet is the next one in sequence. Packet order preservation 64c also provides a timer to monitor the delay of the packets. If the timer runs out at any time during the packet reordering process, the delayed packet is assumed lost and the packets stored in the buffer are forwarded in sequence. The timer value is chosen based on the buffer capacity available and the data rate of the transmission medium.

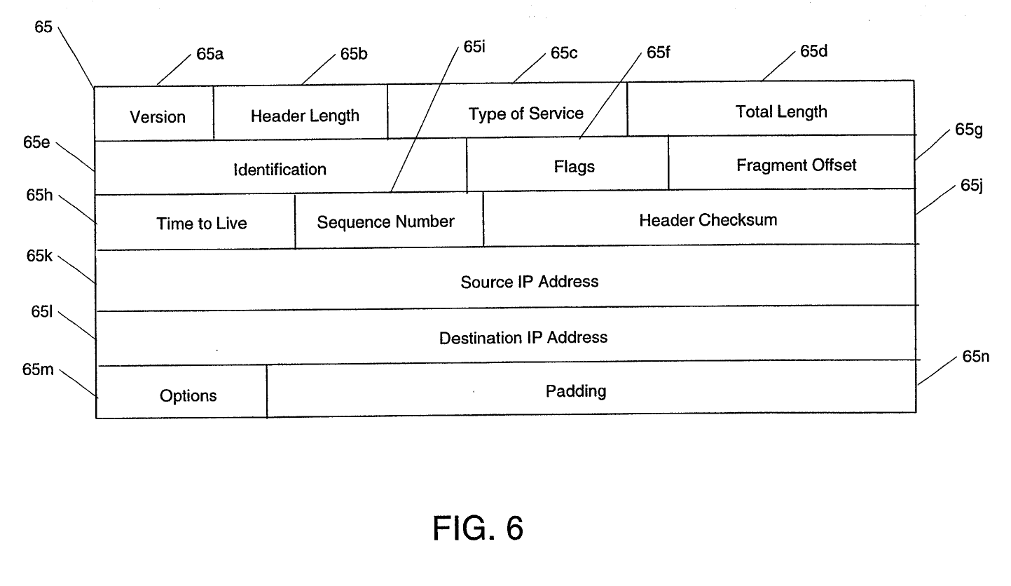

Referring now to FIG. 6, an illustrative trunking protocol header is described. Trunking protocol header 65 contains a variety of fields, including: (1) version 65a; (2) header length 65b; (3) type of service 65c; (4) total length 65d; (5) identification 65e; (6) flags 65f; (7) fragment offset 65g; (8) time to live 65h; (9) sequence number 65i; (10) header checksum 65j; (11) source IP address 65k; (12) destination IP address 651; (13) options 65m; and (14) padding 65n. Source IP address 65k and destination IP address 651 enable the trunking protocol to indicate in each transmitted packet how the packet is to be distributed between an user's site and the SG.

Sequence number 65i is an individual identification number assigned to each packet transmitted for purposes of identifying any packets that may have been lost or delayed due to network congestion or other conditions. In case a packet is delayed, packet order preservation functions provide a buffer for the packets that are not received in sequence until the delayed packet arrives.

In addition, trunking protocol header 65 may contain options field 65m that is used for a variety of miscellaneous functions, such as configuration and enhanced quality of service (QoS) control. It will be understood by one skilled in the art that all other fields in trunking protocol header 65 may perform the same functions as the corresponding fields in a standard IP header format.

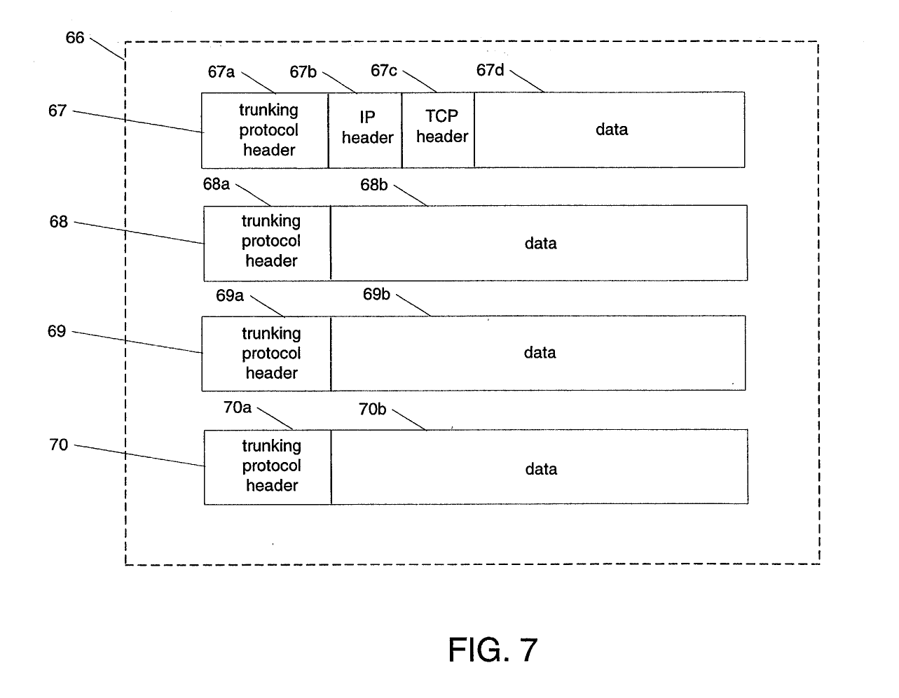

Referring now to FIG. 7, a schematic view of an illustrative packet transmitted in accordance with the principles of the present invention is described. Packet fragments 67-70 contain data 67d, 68b, 69b, and 70b forming packet 66 transmitted between an user's site and an ISP or another user's site. Packet fragments 67-70 also contain trunking protocol headers 67a, 68a, 69a, and 70a, with each header having a sequence number to identify the sequence of the packet fragments and the packets. For example, packet fragment 67 may have sequence number 1, packet fragment 68 may have sequence number 2, packet fragment 69 may have sequence number 3, and packet fragment 70 may have sequence number 4. The choice of sequence numbers is arbitrary, as long as the SG and PSU are aware of the order in which they occur.

Packet fragment 67, being the first packet fragment of packet 66, also includes IP header 67b and TCP header 67c, in accordance with the format established by the IP and TCP/IP protocols. These headers are required in the first packet fragment for the proper network routing to be established. However, the IP and TCP headers do not need to be included in the subsequent packet fragments since the trunking protocol header in each packet fragment is able to provide the necessary information for routing the packets between the PSU and the SG. This capability of the trunking protocol reduces the header overhead incurred in each packet fragment. Further, it will be understood by one skilled in the art that TCP header 67c is not limited to the TCP/IP protocol but may be any other header of a layer four (transport layer) protocol, including the UDP and RTP protocols.

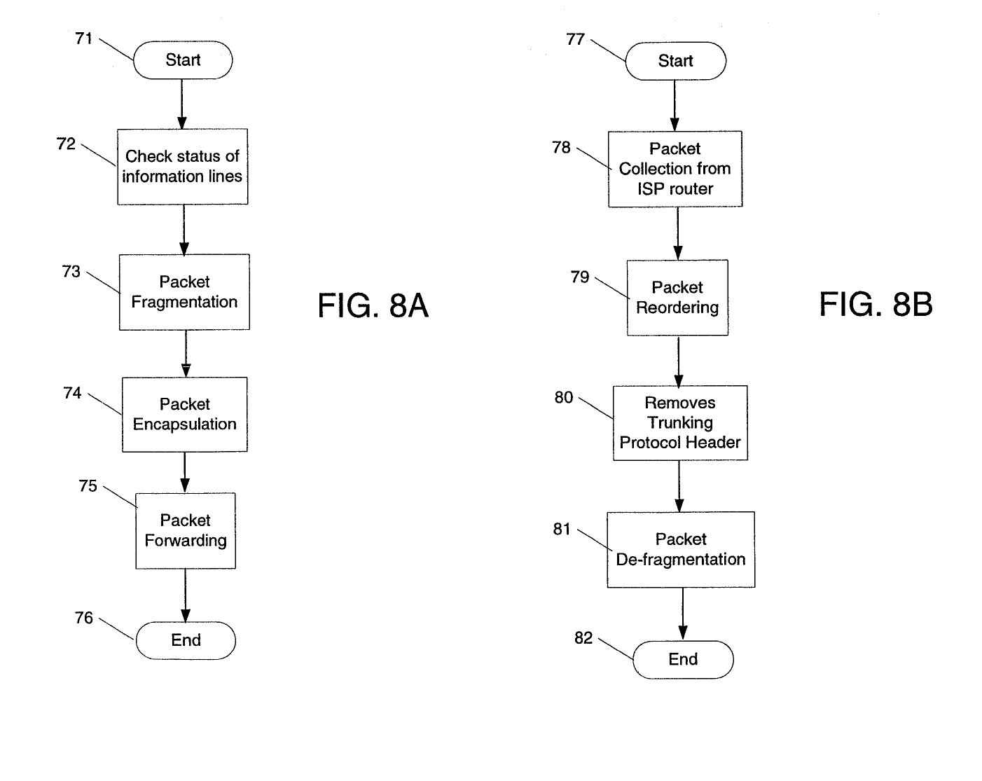

Referring now to FIG. 8A, a flowchart for sending packets from the premises service unit (PSU) to the service gateway (SG) is described. First, at step 72, the PSU checks the configuration and availability of the multiple information lines being aggregated. Second, the PSU fragments the packets (if the packet length is L bytes or greater) to be sent at step 73 so that packet delays due to packet reordering are minimized. Third, each packet (if less than L bytes) or packet fragment is added a trunking protocol header with the destination address of the SG at step 74. Lastly, the packets are forwarded to the SG at step 75.

Referring now to FIG. 8B, a flowchart for receiving packets at the service gateway (SG) from the premises service unit (PSU) is described. First, the SG collects the received packets from the ISP router at step 78 based on the IP address of the SG. Second, the SG reorders the packets to restore them to their original sequence at step 79. Third, the SG removes the trunking protocol header from each packet at step 80. Lastly, at step 81, the packets are de-fragmented to restore them to their original packet length. At this step, any headers that were compressed are restored, including the IP and TCP headers.

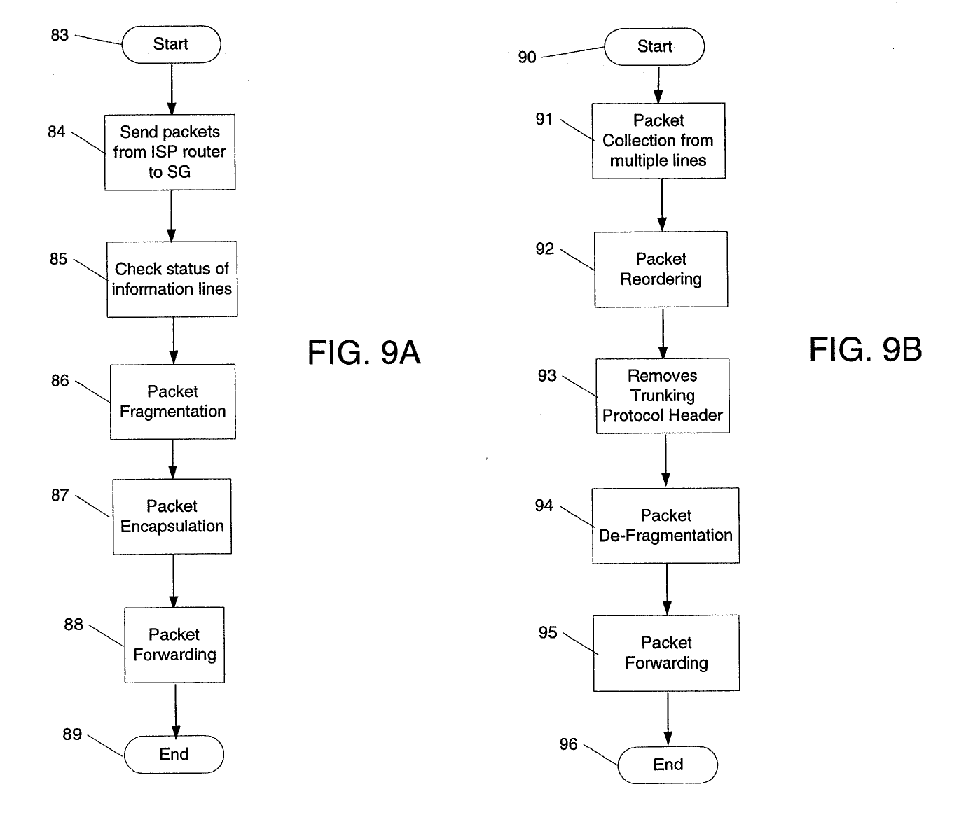

Referring now to FIG. 9A, a flowchart for sending packets from the service gateway (SG) to the premises service unit (PSU) is described. First, at step 84, the ISP router due to prior configuration sends all packets destined for the PSU subnet to the SG. Second, at step 85, SG checks the configuration and availability of the multiple information lines that are aggregated by the PSU. Third, each packet equal to or greater than L bytes is fragmented at step 86. Fourth, at step 87, each packet fragment is added a trunking protocol header with the destination address of the appropriate DSL line connected to the PSU. Lastly, the packets are forwarded to the PSU at-step 88.

Referring now to FIG. 9B, a flowchart for receiving packets at the premises service unit (PSU) from the service gateway (SG) is described. First, the PSU collects the received packets from the multiple information lines at step 91. Second, the PSU reorders the packets to restore them to their original sequence at step 92. Third, the trunking protocol headers are removed at step 93 and the packets are de-fragmented as necessary at step 94. Lastly, at step 95, the packets are forwarded to their final destination at the user's site based on their original IP address.

II. Packet Scheduling Algorithm

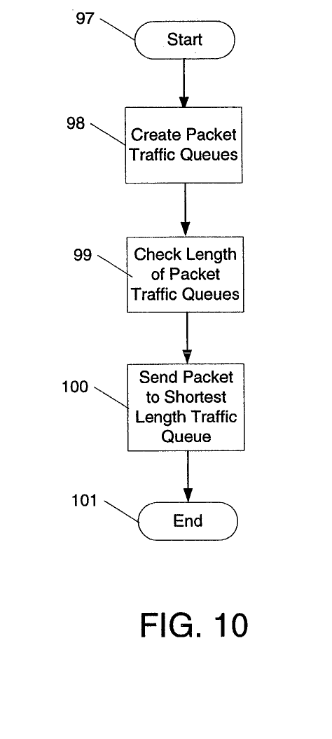

Referring now to FIG. 10, a flowchart of a packet scheduling algorithm for transmitting packets from the user's site to the multiple information lines is described. The packet scheduling algorithm enables efficient packet distribution across each of the information lines being aggregated at the SG or the PSU at the user's site. Each packet is sent on the link that has the shortest queue, so that all the information line capabilities are utilized properly to get the highest available bandwidth at any given time.

At step 98, packet traffic queues are created for each of the information lines being aggregated. The traffic queues contain the packets being transmitted on the information lines at any given time. When a packet is to be transmitted from the user's site or the SG across the information lines, the packet scheduling algorithm checks the length of each traffic queue at step 99 to determine the shortest queue on which to send the packet, and subsequently sends the packet to the information line with the shortest length queue at step 100.

Distributing packets according to the length of each traffic queue results in considerably higher bandwidth utilization than the commonly used round robin algorithm, which simply distributes packets to the lines according to a predetermined order.

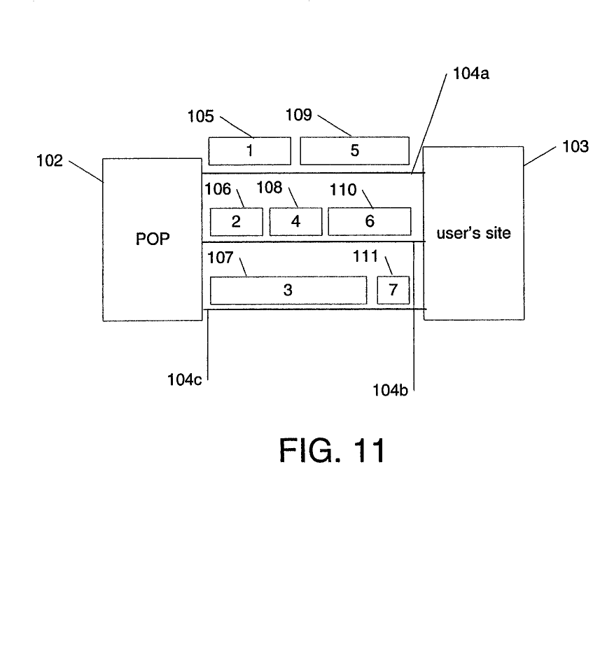

Referring now to FIG. 11, a schematic view of an illustrative packet scheduling session for distributing packets to multiple information lines is described. Rather than simple round robin scheduling onto the multiple lines, which is inefficient, an output queue is created for each DSL line, and each packet is sent on the link that has the shortest queue.

Packets are distributed from user's site 101 to point of presence (POP) 100 in the network. Initially, the packets are distributed in a round-robin fashion, with packet 1 (105) on information line 104a, packet 2 (106) on information line 104b, and packet 3 (107) on information line 104c. When attempting to send packet 4 (108), a simple round-robin algorithm would send the packet to information line 104a, thereby not taking advantage of the extra bandwidth available in information line 104b due to its shortest output queue. Here, the packet scheduling algorithm first checks the length of the output queues of all information lines prior to sending the packet so that packet 4 (108) is sent onto the information line having the shortest queue, in this case, information line 104b. With this strategy, packet 5 (109) is sent to information line 104a, packet 6 (110) is sent to information line 104b, and packet 7 (111) is sent to information line 104c.

As a result, all the line capacities are utilized properly to get the higher bandwidth. The drawback is the need for extra computation time and possibly more buffering to implement as compared to a standard round-robin algorithm.

III. Information Channel Aggregation Controller

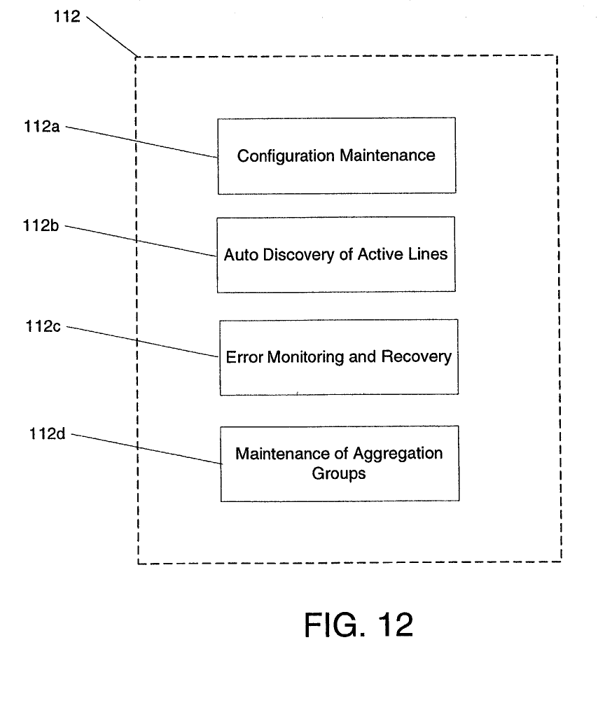

Referring now to FIG. 12, a schematic view of the functionalities provided by the information channel aggregation controller is described. Information channel aggregation controller functionalities 112 include: (1) configuration maintenance 112a; (2) auto discovery of active lines 112b; (3) error monitoring and recovery 112c; and (4) maintenance of aggregation groups 112d.

First, configuration maintenance function 112a keeps track of both static and dynamic configuration information for the information lines. Static configuration information is local to the information lines and may include parameter values associated with the information lines, static configuration information properties associated with any existing aggregation group, and the status of each line at any given time to determine which lines are active or not.

Further, static configuration information includes the identity of the remote pair of systems that the lines are connected between, the set of characteristics that each of those systems has associated with a particular line, and whether both systems understand the same information regarding the line. In contrast, dynamic configuration information involves any information that is exchanged with the other information channel aggregation controller reachable via the information lines.

Second, auto discovery of active lines function 112b enables the trunking protocol to monitor the multiple information lines at the user's site to find out whether they are active or not. Active lines are those that are functioning normally, without being disrupted by adverse network conditions.

Third, error monitoring and recovery function 112c enable the trunking protocol to properly handle failures in any of the multiple information lines. When a failure occurs, error monitoring and recovery function 112c effectively assigns a non-active status to the failed information line, and re-routes the traffic in that line to the other active lines.

Lastly, maintenance of aggregation groups function 112d is responsible for forming aggregation groups containing a subset or all of the lines being aggregated, monitoring the status of aggregated lines to ensure that the aggregation is still valid, and adding and removing lines from a given aggregation group. An information line may be included in an aggregation group if its static configuration permits aggregation, and further, if the line is active.

Before a line can be added to an aggregation group, it is necessary to check that the information on which the information channel controller decided that the line is a candidate for aggregation is still valid, and that all necessary static configuration parameters for the line being aggregated are known. Auto discovery of active lines function 112b is then used to validate any existing knowledge related to that line and to determine the characteristics of the line. If a line is both a candidate for aggregation, and all of its parameters have been successfully checked, then the line will be added to an aggregation group.

Each line that belongs to an aggregation group is monitored to confirm that the information channel controllers at each end of the line still agree in configuration information for that link. If the monitoring process detects a change in configuration that materially affects the line's membership in its current aggregation group, then it becomes necessary to remove the line from the group.

Removal of a line from an-aggregation group involves informing the packet distribution function that the line is no longer part of the group, communicating the changed configuration information to the other end of the line, and informing the packet collection function at either the PSU at the user's site or at the SG at the ISP that the line is no longer part of the group.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A system for aggregating multiple information channels across a network, the system comprising:
modules implementing a trunking protocol transparent to layer one and layer two of the network layer hierarchy using packet encapsulation and fragmentation;
modules implementing a packet scheduling algorithm for distributing packets across the information channels being aggregated; and
modules implementing an information channel aggregation controller for controlling the information channels being aggregated.

2. The system of claim 1, wherein the information channels comprise standard modem connections.

3. The system of claim 1, wherein the information channels comprise DSL lines.

4. The system of claim 1, wherein the information channels comprise T1 lines.

5. The system of claim 1, wherein the information channels comprise T3 lines.

6. The system of claim 1, wherein the information channels comprise layer one and layer two technologies.

7. The system of claim 1, wherein the information channels comprise a combination of two or more of the following: standard modem connections; DSL lines; T1 lines; T3 lines; and layer one and layer two technologies.

8. The system of claim 1, wherein layer one of the network layer hierarchy comprises the physical layer of the OSI reference model.

9. The system of claim 1, wherein layer two of the network layer hierarchy comprises the data link layer of the OSI reference model.

10. The system of claim 1, wherein the modules implementing the trunking protocol manage the distribution of packets across the network, the trunking protocol modules comprising:
a packet encapsulation routine;
a packet fragmentation routine; and
a packet order preservation routine.

11. The system of claim 10, wherein the packet encapsulation routine comprises either one or both of software or logic for generating a trunking protocol header and inserting the trunking protocol header in a packet.

12. The system of claim 11, wherein the trunking protocol header comprises a sequence number and a plurality of fields compliant with the Internet protocol.

13. The system of claim 10, wherein the packet fragmentation routine comprises either one or both of software and logic for fragmenting a packet formed by the Internet protocol into smaller packet fragments so that the transmission rate of the aggregated information channels is optimized.

14. The system of claim 13, wherein either one or both of software or logic for fragmenting a packet formed by the Internet protocol into smaller packet fragments comprises:
either one or both of software and logic for inserting a layer four protocol header and an Internet protocol header into a single packet fragment; and
either one or both of software and logic for inserting the trunking protocol header into all packet fragments.

15. The system of claim 14, wherein layer four comprises the transport layer of the OSI reference model.

16. The system of claim 10, wherein the packet order preservation routine comprises:
either one or both of software and logic for identifying out-of-sequence packets;
either one or both of software and logic for providing a buffer for storing out-of-sequence packets;
either one or both of software and logic for providing a timer for monitoring the delay of packets; and
either one or both of software and logic for ordering the out-of-sequence packets.

17. The system of claim 1, wherein the packet scheduling algorithm modules comprise:
either one or both of software or logic for creating packet traffic queues;
either one or both of software or logic for checking the length of the packet traffic queues; and
either one or both of software or logic for sending a packet to the shortest length packet traffic queue.

18. The system of claim 1, wherein the information channel aggregation controller modules comprise:
a configuration maintenance routine;
an auto discovery of active lines routine;
an error monitoring and recovery routine; and
a maintenance of aggregation groups routine.

19. The system of claim 18, wherein the configuration maintenance routine comprises managing static and dynamic configuration information for the information channels.

20. The system of claim 19, wherein the static configuration information comprises:
parameters associated with the information channels;
properties associated with the aggregation groups; and
status information associated with the information channels indicating the information channels that are active and non-active.

21. The system of claim 19, wherein the dynamic configuration information comprises information exchanged with other information channel aggregation controllers reachable across the information channels.

22. The system of claim 18, wherein the auto discovery of active lines routine comprises either one or both of software and logic for monitoring the status information associated with the information channels to reveal the information channels that are active.

23. The system of claim 18, wherein the error monitoring and recovery routine comprises:
either one or both of software and logic for monitoring network failures in the information channels;
either one or both of software and logic for modifying the status information associated with the information channels experiencing network failures to indicate that the information channels experiencing network failures are non-active; and
either one or both of software and logic for rerouting the traffic in the information channels experiencing network failures to other information channels.

24. The system of claim 18, wherein the maintenance of aggregation groups routine comprises:
either one or both of software and logic for forming aggregation groups comprising a subset or all of the information channels being aggregated;
either one or both of software and logic for monitoring the static and dynamic information associated with the information channels to ensure that the information channels being aggregated are active;
either one or both of software and logic for adding information channels to the aggregation groups; and
either one or both of software and logic for removing information channels from the aggregation groups.

25. The system of claim 24, wherein the software and logic for removing information channels from the aggregation groups comprise either one or both of software and logic for updating static configuration information associated with the information channels being removed.

26. A method for aggregating multiple information channels across a network, the method comprising:
providing a trunking protocol transparent to layer one and layer two of the network layer hierarchy using packet fragmentation and encapsulation;
scheduling packets across each of the information channels being aggregated; and
controlling the information channels being aggregated.

27. The method of claim 26, wherein the information channels comprise standard modem connections.

28. The method of claim 26, wherein the information channels comprise DSL lines.

29. The method of claim 26, wherein the information channels comprise T1 lines.

30. The method of claim 26, wherein the information channels comprise T3 lines.

31. The method of claim 26, wherein the information channels comprise layer one and layer two technologies.

32. The method of claim 26, wherein the information channels comprise a combination of two or more of the following: standard modem connections; DSL lines; T1 lines; T3 lines; and other layer one and layer two technologies.

33. The method of claim 26, wherein layer one of the network layer hierarchy comprises the physical layer of the OSI reference model.

34. The method of claim 26, wherein layer two of the network layer hierarchy comprises the data link layer of the OSI reference model.

35. The method of claim 26, wherein the trunking protocol manages the distribution of packets across the network, the trunking protocol comprising:
a packet encapsulation routine;
a packet fragmentation routine; and
a packet order preservation routine.

36. The method of claim 35, wherein the packet encapsulation routine comprises generating a trunking protocol header and inserting the trunking protocol header in a packet.

37. The method of claim 36, wherein the trunking protocol header comprises a sequence number and a plurality of fields compliant with the Internet protocol.

38. The method of claim 35, wherein the packet fragmentation routine comprises fragmenting a packet formed by the Internet protocol into smaller packet fragments so that the transmission rate of the aggregated information channels is optimized.

39. The method of claim 38, wherein fragmenting a packet formed by the Internet protocol into smaller packet fragments comprises:
preserving a layer four protocol header and an Internet protocol header in a single packet fragment; and
inserting the trunking protocol header into all packet fragments.

40. The method of claim 39, wherein layer four comprises the transport layer of the OSI reference model.

41. The method of claim 35, wherein the packet order preservation routine comprises:
identifying out-of-sequence packets;
providing a buffer for storing out-of-sequence packets;
providing a timer for monitoring the delay of packets; and
ordering the out-of-sequence packets.

42. The method of claim 26, wherein scheduling packets across each of the information channels being aggregated comprises:
creating packet traffic queues associated with each information channel being aggregated;
checking the length of the packet traffic queues; and
sending a packet to the shortest length packet traffic queue.

43. The method of claim 26, wherein controlling the information channels being aggregated comprises:
managing configuration information associated with the information channels;
monitoring the configuration information associated with the information channels to reveal the information channels that are active;
monitoring network failures in the information channels;
modifying the configuration information associated with the information channels experiencing network failures to indicate that the information channels experiencing network failures are non-active;
forming aggregation groups comprising a subset or all of the information channels being aggregated;
adding information channels to the aggregation groups; and
removing information channels from the aggregation groups.

44. A system for aggregating multiple information channels across a network, the system comprising:
a premises service unit for aggregating multiple information channels at a user's site;
a service gateway unit for aggregating multiple information channels at the user's site or within the network; and
a trunking protocol transparent to layer one and layer two of the network layer hierarchy for distributing packets between the premises service unit and the service gateway unit using packet fragmentation and encapsulation.

45. The system of claim 44, wherein the information channels comprise standard modem connections.

46. The system of claim 44, wherein the information channels comprise DSL lines.

47. The system of claim 44, wherein the information channels comprise T1 lines.

48. The system of claim 44, wherein the information channels comprise T3 lines.

49. The system of claim 44, wherein the information channels comprise layer one and layer two technologies.

50. The system of claim 44, wherein the information channels comprise a combination of two or more of the following: standard modem connections; DSL lines; T1 lines; T3 lines; and layer one and layer two technologies.

51. The system of claim 44, wherein layer one of the network layer hierarchy comprises the physical layer of the OSI reference model.

52. The system of claim 44, wherein layer two of the network layer hierarchy comprises the data link layer of the OSI reference model.

53. The system of claim 44, wherein the premises service unit comprises:
modules implementing a packet scheduling algorithm for distributing the packets to the multiple information channels;
modules implementing a packet collection software routine for collecting packets from the multiple information channels;
modules implementing an aggregation controller software routine for controlling the information channels being aggregated;
modules for implementing a packet encapsulation software routine for generating a trunking protocol header and inserting the trunking protocol header in a packet;
modules for implementing a packet fragmentation software routine for fragmenting a packet formed by the Internet protocol into smaller packet fragments;
modules for implementing a packet reordering routine for ordering packets that are out-of-sequence;
modules for implementing a trunking protocol header removal software routine for removing the trunking protocol header from packets to be distributed across the user's site;
modules for implementing a packet de-fragmentation software routine for restoring the packets to their original packet length; and
modules for implementing a packet forwarding software routine for forwarding the packets to the service gateway unit and across the user's site.

54. The system of claim 53, wherein the trunking protocol header comprises a sequence number and a plurality of fields compliant with the Internet protocol.

55. The system of claim 53, wherein the packet scheduling algorithm modules comprises:
software routines for creating packet traffic queues;
software routines for checking the length of the packet traffic queues; and
software routines for sending a packet to the shortest length packet traffic queue.

56. The system of claim 53, wherein the modules implementing an aggregation controller software routine comprise:
a configuration maintenance software routine for managing configuration information associated with the information channels being aggregated;
an auto discovery of active lines software routine for monitoring the configuration information associated with the information channels to reveal the information channels that are active;
an error monitoring and recovery software routine; and
a maintenance of aggregation groups software routine.

57. The system of claim 56, wherein the error monitoring and recovery software routine comprises:
monitoring network failures in the information channels;
modifying the configuration information associated with the information channels experiencing network failures to indicate that the information channels experiencing network failures are non-active; and
re-routing the traffic in the information channels experiencing network failures to other information channels.

58. The system of claim 56, wherein the maintenance of aggregation groups software routine comprises:
forming aggregation groups comprising a subset or all of the information channels being aggregated;
monitoring the configuration information associated with the information channels to ensure that the information channels being aggregated are active;
adding information channels to the aggregation groups; and
removing information channels from the aggregation groups.

59. The system of claim 44, wherein the service gateway unit comprises:
modules implementing a packet forwarding routine for sending all packets destined for the premises service unit from a router to the service gateway unit;
modules implementing a packet scheduling algorithm for distributing the packets to the multiple information channels;
modules implementing a packet collection software routine for collecting packets from the router;
modules implementing an aggregation controller software routine for controlling the information channels being aggregated;
modules for implementing a packet encapsulation software routine for generating a trunking protocol header and inserting the trunking protocol header in a packet;
modules for implementing a packet fragmentation software routine for fragmenting a packet formed by the Internet protocol into smaller packet fragments;
modules for implementing a packet reordering routine for ordering packets that are out-of-sequence;
modules for implementing a trunking protocol header removal software routine for removing the trunking protocol header from packets to be distributed to the Internet;
modules for implementing a packet de-fragmentation software routine for restoring the packets to their original packet length; and
modules for implementing a packet forwarding software routine for forwarding the packets to the premises service unit and to the Internet.

60. The system of claim 59, wherein the trunking protocol header comprises a sequence number and a plurality of fields compliant with the Internet protocol.

61. The system of claim 59, wherein the packet scheduling algorithm modules comprises:
software routines for creating packet traffic queues;
software routines for checking the length of the packet traffic queues; and
software routines for sending a packet to the shortest length packet traffic queue.

62. The system of claim 44, wherein the trunking protocol comprises:
a packet encapsulation software routine;
a packet fragmentation software routine; and
a packet order preservation software routine.

63. The system of claim 62, wherein the packet encapsulation software routine comprises generating a trunking protocol header and inserting the trunking protocol header in a packet.

64. The system of claim 63, wherein the trunking protocol header comprises a sequence number and a plurality of fields compliant with the Internet protocol.

65. The system of claim 62, wherein the packet fragmentation software routine comprises fragmenting a packet formed by the Internet protocol into smaller packet fragments so that the transmission rate of the aggregated information channels is optimized.

66. The system of claim 65, wherein fragmenting a packet formed by the Internet protocol into smaller packet fragments comprises:
inserting a layer four protocol header and an Internet protocol header into a single packet fragment; and
inserting the trunking protocol header into all packet fragments.

67. The system of claim 66, wherein layer four comprises the transport layer of the OSI reference model.

68. The system of claim 62, wherein the packet order preservation routine comprises:
identifying out-of-sequence packets;
providing a buffer for storing out-of-sequence packets;
providing a timer for monitoring the delay of packets; and
ordering the out-of-sequence packets.
